(19) United States
(12) Patent Application Publication
(10) Pub. No.: US 2004/0251191 A1
(43) Pub. Date: Dec. 16, 2004

(54) Method of liquid purification using ion exchange resin being kept in a compacted state by means of elastic material

(76) Inventor: Arianto Darmawan, Bandung (ID)

Correspondence Address: CHRISTIE, PARKER & HALE, LLP, PO BOX 7068, PASADENA, CA, 91109-7068, US

(21) Appl. No.: 10/493,321

(22) PCT Filed: Mar. 28, 2002
(86) PCT No.: PCT/IB02/01031

(30) Foreign Application Priority Data
Dec. 10, 2001 (ID) P0100959

(51) Int. Cl. C02F 1/42

(52) U.S. Cl. 210/275; 210/287

(57) ABSTRACT

A liquid purification system and method using ion exchange resin is provided in which the ion exchange resin is kept in a compacted state by means of elastic material. Since the resin is always compacted, high efficiency of the process is obtained which yields high quality product and low regenerant consumption. Furthermore, this system may use larger tank with larger volume of resin so that longer service interval can be obtained because the system is not affected by low service and regenerant flow rates. An integrated backwash tank is provided in which the resin to be backwashed is transferred to the backwash tank and returned to the main column when backwashing is finished.

### FIELD OF INVENTION

This invention is concerned with processes of liquid purification system using ion exchange and in particular forms is related to method for demineralizing or softening of water, purification of aquaous solution, recovery of metals and valuable compounds.

### BACKGROUND OF INVENTION

Ion exchange system is a process of liquid purification. Generally this process uses ion exchange resin or adsorbent resin.

Ion exchange resins are polymeric beads, granulas or powders having a functional acidic group called cation resin and basic group called anion. They work by exchanging ions in a solution with ions fixed inside the porous polymer matrix of the resin. Adsorbent resins are more porous and work by attracting materials onto the large surfaces of the resin.

In most cases involving ion exchange system the resin is confined in a column. The system may contain on or more columns filled with one or more types of resin of the same or different function. The particular advantage of such ion exchange liquid purification system as described above lies in thier effectiveness high efficiency, simplicity and low operating cost compared to other purification processes such as evaporation, reverse osmosis and the like. Successful liquid purification processes using ion exchange system depend in major part, upon the characteristic of the system utilized. Among the desired characteristics are:

1. High purity of the processed product.

The system must be able to ensure production of high quality of demineralized or adsorbed product. It should keep the resin bed in a compacted form and reduce the ion leakage.

2. Low chemical consumption

Regeneration of the exhausted resin should be performed efficiently for optimum chemical consumption and should maximize the resin bed operating capacity such as to produce the most highly regenerated resin at the service flow outlet.

3. Less waste during regeneration

Regeneration is to be performed efficiently, less time, less water consumption for backwashing and rinsing, and less chemical waste.

4. Reduced pressure drop

High flow rate increases pressure drop. High pressure drop increases possibility of breakage of the resin beads and causes higher pumping energy.

5. Wide range of flow rates

Since most processes are not constant the system should be operable for processes at wide range of flow rates and is still capable to produce highly purified product.

6. Low operating and investment cost

The system should be easily operable with low operating, investment and maintenance costs.

The following basic ion exchange systems are generally available.

The first system is a cocurrent system where the direction of flow during service is from top to bottom while the regeneration process is also from top to bottom (DEGREMONT, WATER TREATMENT HANDBOOK, 5^{th} EDITION, JOHN WILEY & SONS 1979 PAGE 319-320). In this system the resin bed is compacted during service and regeneration. During service the liquid is passed through a column which contains resin beads supported by underdrain which normally contains nozzles at the bottom of the tank. There is a free board above the surface of the resin almost as high as the resin bed to allow the resin bed to be effectively backwashed before the regeneration process to clean and remove the small broken particles. This cocurrent system is widely used since it is simple but requires plenty of regenerant. Because the regenerant flow is from top to bottom the highly regenerated resin bed is at the service flow inlet while the lower regenerated resin bed is at the service flow outlet. Therefore the purity of the processed products is not very high. This system requires a lot of regenerant and should be backwashed before each regeneration process.

The second system is a counter current system where the direction of flow during service is from top to bottom while the flow of the regeneration process is from bottom to top (THE UPCORE SYSTEM, DOW CHEMICAL COMPANY, FORM No. 17701527895 CH 17280 E 0895 R). The upper part of the column is equipped with upper bed containing nozzles identical to that of the underdrain bed. There is a free board above the resin bed to accommodate 5-10% expansion of the resin bed after being exhausted.

The disadvantage of this system is that during the regeneration process, where the regenerant flow is from bottom to top, the resin will not be fully compacted due to the tendency of fluidization which causes the regeneration process less effective. Because of the low upflow speed of the limited quantity of regenerant as well as the tendency of the resin bed to fall down due to the higher specific gravity of the resin as compared to that of the liquid, more regenerant are required during regeneration although it is still less than that of the cocurrent system.

Tank diameter is correlated to the upflow speed of the regenerant. Increasing the upflow speed requires smaller tank diameter and smaller resin volume and therefore shorter regeneration cycle.

There is no backwashing facility and the resin should be discharged from the column if the pressure drop of the system exceeds the limit due to the accumulation of the broken resin particles on the nozzles opening. This system requires specially sized resin with more uniform particles to reduce pressure drop.

The third system is a counter current system where the direction of flow during service is from bottom to top and the regeneration process is conducted from top to bottom (AMBERPACK BACKWASHABLE PACKED BED SYSTEM [EXTERNAL BACKWASHING] ROHM AND HASS; PRINT INF 9003 A DEC 93 IMPACTES RCS B 350424636). The upper part of the column is equipped with upper bed which contains nozzles identical to that of the underdrain bed. There is a free board above the resin bed to accommodate 5% to 10% expansion of the resin bed after being exhausted.

The disadvantage of this system is that during service, where the flow is from bottom to top, the flow speed must be relatively high in order to obtain a compacted resin bed. In many operations the service flow rate is fluctuating or interupted which causes fluidization or fall of the resin bed. This makes the resin bed uncompacted and contaminates the highly regenerated resin at the flow outlet which will reduce the water quality and exchange capacity.

Small broken resin particles tends to rise to the top and resin fines with the size smaller than the nozzle openings may be transported and contaminate the other ion exchange vessel. To protect the system a resin trap should be installed, but it will increase the pressure drop. There is no internal backwashing facility and the resin should be discharged to be backwashed outside of the column if the pressure drop of the system exceeds the limit due to the accumulation of the broken resin particles having sizes larger than the nozzle openings. This system requires specially sized resin with more uniform particles to reduce pressure drop.

U.S. Pat. No. 1,688,915 (year: 1928) utilizes two connected compartments as apparatus for treating liquids. This invention emphasized that no screen are required for carrying the weight of the softening material because the weight of the softening material is carried directly by the tanks or containers themselves. No compaction of the softening material and counter current effect was intended.

One can understand this phenomenon since at the time this invention was filed, softening material contain mostly of minerals which are much heavier than nowadays resin. This system does not have a separate backwashing port.

The tank diameter is correlated with the upflow speed during service where increasing the speed requires smaller tank diameter and therefore yields smaller resin volume and consequently shorter regeneration cycle.

The fourth system is a counter current system with water or air hold down (COUNTER CURRENT ION EXCHANGE SYSTEMS IN INDUSTRIAL AND UTILITY WATER TREATMENT. V. R. DAVIES. ROHM AND HAAS COMPANY, MARCH 1989). This system is a down flow service and upflow regeneration. In the water hold down system, there is a free board above the resin bed with distributor at the top. Regenerant exit distributor is buried just below the upper surface of the resin bed.

During regeneration cycle, the regenerant will flow upward from the bottom and exit through this collector while at the same time water will flow downward from the distributor through this exit distributor to maintain packed resin bed. In the air hold down system, air is used instead of water for the regeneration process.

The disadvantage of this system is that it requires a relatively large quantity of water or air during regeneration to compact the resin bed. Besides, the operation and maintenance are more complicated.

Counter current system shows advantages over cocurrent system. During regeneration process the resin bed at the regenerant inlet will be highly regenerated with the highest exchange capacity while the resin bed at the regenerant outlet will remain partially in the exhausted stage and has lower exchange capacity. In the cocurrent system where the service inlet is the same as the regenerant inlet, this partially exhausted stage will affect the leakage influencing the quality of the treated liquid. It is possible to increase the quality of the treated liquid by imposing higher regeneration level to convert the partially exhausted stage resin to become more highly regenerated but it will be less economical.

In the counter current system the outlet liquid will be in contact with highly regenerated portion of the resin during the service which yields much higher quality of processed liquid with Less leakage and less regenerant cycle.

### SUMMARY OF INVENTION

The principal objective of this invention is developing a design of an ion exchange system for producing the highest purity of processed product with the following features: low chemical consumption, easy operation and maintenance, less waste, low operating cost, low investment cost and has a wide range of application.

Another objective of this invention is developing a design of a counter current ion exchange system which can tolerate changes of flow rates during service cycle or even interuption of service flow. Furthermore the system should have the capability of backwashing whenever required to remove the resin fines if the pressure drop exceeds the expected limit. The system can be operated at low service flow rate with low pressure drop so that besides specially sized resin, standard sized resin may be used.

The aforementioned principal objective has been achieved by building a system operating on a counter current base where the resin is always compacted during service cycle, regenerated cycle or even when the flow is interupted. The system is also provided with backwashing facility where the backwashing flow rate can be adjusted. The backwasliing is in effect only if the pressure drop of the system increases such as to exceed a certain limit. In normal condition backwashing is required only after more than one hundred regeneration cycles, so there is practically no backwashed waste water in the regeneration process except once a year or whenever required.

The design of the system of this invention in general comprises a vertical column with upper and lower nozzle beds or nozzle arrays. It is filled with one or more types of ion exchange resins. Further the system is equipped with an elastic material which will compress the resin bed in the column such that the resin is always compacted during service and regeneration process. Due to the elasticity of the elastic material, expansion during regeneration and retraction during service can be accomodated to keep the resin bed always in compacted state. One of the configuration of the elastic material may be in the form of an elastic flowthrough sheet with small perforation such that the liquid may pass through while the resin particles will still be retained. Alternatively the elastic material may be a non-flowthrough elastic sheet where both the liquid as well as the resin will not pass through. Another configuration includes the use of elastic flowthrough or non-flowthrough compressible paddings. These paddings may be in the form of compressible foam or solid elastic materials. The direction of service flow can be conducted downward from top to bottom and the regeneration process is conducted from bottom to top. Alternatively, the direction of service flow may be conducted upward from bottom to top and the regeneration process downward from top to bottom. The system is equipped with backwashing facility using external interconnected tank. Depending on the necessity the backwashing may be conducted for the upper portion, the lower portion or the whole resin bed. The position of the elastic material can be set at the top or at the bottom of the resin bed or at both sides of the resin bed or at any position between the bottom and the upper surface of the resin bed. In case the elastic material is positioned between the upper surface and the bottom side of the resin bed, it should be able to allow the flow of the liquid to pass through. The resin layer at the upper and the lower compartment can be backwashed individually. The position of the column can be configured at any angle from vertical to horizontal position.

It has been discovered that the resin bed remains compacted even when the cycle of the system is interrupted. This is because the elastic material always compresses the resin bed at any cycle of operation.

Compacted bed increases the performance of regeneration and service cycle. During regeneration a compacted bed will keep the resin bed firm so that the exchange of ions will be most effective with the highly regenerated zone at the regenerant inlet which is also the service outlet of the service cycle.

Nevertheles this system is equipped with integrated backwashing system. After several hundreds of operation cycles broken resin particles of sizes larger than nozzle opening may accumulate which will increase the pressure drop above the acceptable limit. Backwashing is to be conducted by transferring the resin to a backwash tank through the upper backwash port and after being backwashed the resin is transferred back to the resin column through the lower backwash port.

Another advantage of this system compared to other cocurrent systems is that this system may use larger tank with larger volume of resin so that longer service interval can be obtained because this system is not affected by low service and regeneration flow rates, where the quality of the treated product is very high due to the compaction of the resin during regeneration and service.

### BRIEF DESCRIPTION OF FIGURES

The present invention will now be further described in the accompanying drawings, in which:

FIG. 1 is a schematic representation of a currently available cocurrent system (the prior art).

FIG. 2A is a schematic representation of a currently available counter current system with down flow service and upflow regeneration (the prior art) operating in the normal down flow service mode.

FIG. 2B is a schematic representation of a currently available counter current system with down flow service and upflow regeneration (the prior art) operating in the backwash mode.

FIG. 3A is a schematic representation of a currently available counter current system with upflow service and down flow regeneration (the prior art) operating in the normal upflow service mode.

FIG. 3B is a schematic representation of a currently available counter current system with upflow service and down flow regeneration (the prior art) operating in the backwash mode.

FIG. 4A is a schematic representation of liquid purification system according to the present invention with flowthrough elastic material at the upper part of the column, where the service flow is downward and the regeneration flow is upward or vice versa.

FIG. 4B is a schematic representation of liquid purification system according to the present invention with non-flowthrough elastic material at the upper part of the column, where the service flow is downward and the regeneration flow is upward or vice versa.

FIG. 4C is a schematic representation of liquid purification system according to the present invention as FIG. 4A with integrated backwash talk.

FIG. 4D is a schematic representation of separation system according to the present invention as FIG. 4B with integrated backwash tank.

FIG. 5A is a schematic representation of liquid purification system according to the present invention with flowthrough elastic material at the lower part of the column, where the service flow is downward and the regeneration flow is upward or vice versa.

FIG. 5B is a schematic representation of liquid purification system according to the present invention with non-flowthrough elastic material at the lower part of the column, where the service flow is downward and the regeneration flow is upward or vice versa.

FIG. 5C is a schematic representation of liquid purification system according to the present invention as FIG. 5A with integrated backwash tank.

FIG. 5D is a schematic representation of liquid purification system according to the present invention as FIG. 5B with integrated backwash tank.

FIG. 6A is a schematic representation of liquid purification system according to the present invention with flowthrough elastic material embedded in the resin bed where the service flow is downward and the regeneration flow is upward or vice versa.

FIG. 6B is a schematic representation of liquid purification system according to the present invention as FIG. 6A with integrated backwash tank.

FIG. 7A is a schematic representation of liquid purification system according to the present invention where the column is positioned horizontally and the service flow is from the left to the right while the regeneration flow is from the right to the left or vice versa.

FIG. 7B is a schematic representation of liquid purification system according to the present invention as FIG. 7A with integrated backwash tank.

### COMPLETE DESCRIPTION OF INVENTION

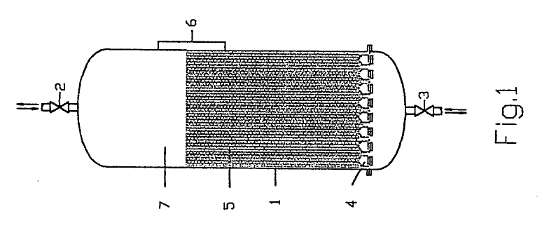

FIG. 1 is a simplified schematic representation of a currently cocurrent system (the prior art}. Column 1 with nozzle equipped underdrain bed 4 is filled with ion exchange resin about 50% to 60% of the total volume. Above the resin bed is freeboard 7. During service the liquid flows from port 2, which comes into contact with the compacted resin bed 5 and flows out to the outlet through port 3. During regeneration the direction of flow of the regenerant is identical to the service operation. Before the regeneration the resin is to be backwashed with the direction of flow from port 3 as the inlet to the outlet through port 2. This upflow direction will fluidize the resin bed 5, and resin fines and contaminated particles will be removed during this process. The resin level and backwash effectiveness can be monitored through sight glass 6.

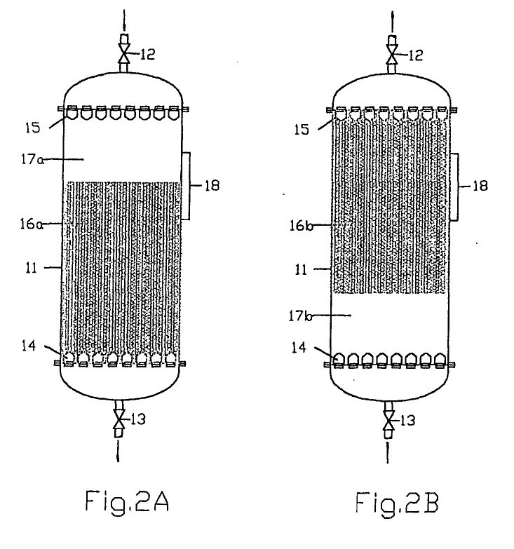

FIG. 2a and 2b are schematic representations of a currently available counter current system with down flow service and upflow regeneration (the prior art). Column 11 with nozzle equipped underdrain bed 14 and upper bed 15 is filled with ion exchange resin. During service (FIG. 2a) the fluid is directed through port 12 passing the compacted resin bed 16a with outlet at port 13. During regeneration (FIG. 2b) the regenerant passes through port 13 with outflow through port 12. The resin will not be compacted and this will affect the regeneration efficiency. The level of the resin can be monitored from sight glass 18. Free board 17a and 17b are about 20 cm to 30 cm height just to allow the resin to expand during service operation. This system does not have an internal backwashing system. Therefore when the resin has to be backwashed it should be removed from the column to an external resin cleaning system.

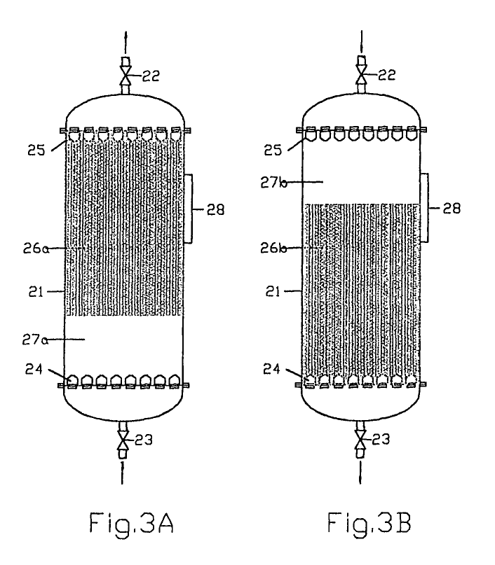

FIGS. 3a and 3b are schematic representations of a currently available counter current system with upflow service and down flow regeneration (the prior art). Column 21 with nozzle equipped underdrain bed 24 and upper bed 25 is filled with ion exchange resin. During service (FIG. 3a) the fluid flows through port 23, passes the compacted resin bed 26a and flows out through port 22. The service flow should be controlled at such a speed to maintain the resin bed in a compacted state so that the counter current regeneration profile of the resin will always be obtained. Lower speed or interupting the flow will cause the resin not in a compacted state and destroy the regeneration profile of the resin which will affect the quality of the treated liquid.

During regeneration (FIG. 3b) the regenerant passes through port 22 with outflow through port 22. In this cycle the resin bed is always compacted and the regeneration efficiency is high. The level of the resin can be monitored through sight glass 28. Free board 27a and 27b are of about 20 to 30 cm height to allow the resin to expand during the service operation.

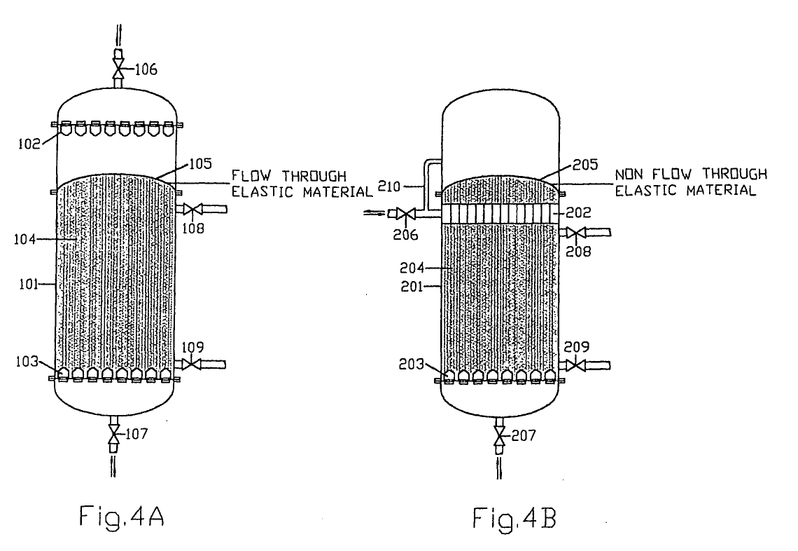

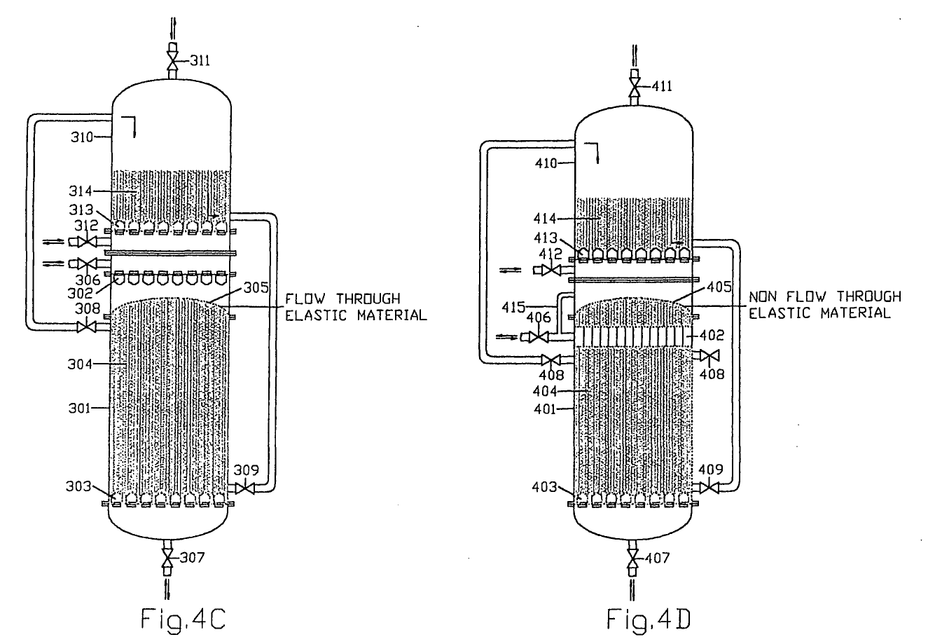

FIG. 4A is a schematic representation of liquid purification system according to the present invention using a flowthrough elastic material. Column 101 is equipped with nozzle array 102 at the upper part and another nozzle array 103 at the lower part. The column is filled with resin 104. A flowthrough elastic material 105 is compacting the resin and maintains the resin in a compacted state during any cycle of operation. The elastic material accomodates the expansion of the resin bed during regeneration and the retraction during service.

During service mode with downward direction the fluid flows from upper port 106 equipped with valve, passes nozzle array 102, flowthrough elastic material 105, resin bed 104, lower nozzle array 103 and outlets at port equipped with valve 107.

During regeneration mode the regenerant flows through port 107 equipped with valve, passes through lower nozzle array 103, resin bed 104, flowthrough elastic material 105, upper nozzle array 102 with outlet at port equipped with valve 106.

The upper backwash port equipped with valve 108 is used to transfer the resin out of the column and the lower backwash port equipped with valve 109 is used to transfer the resin back to the column.

If the direction of the service mode is upward, the direction of the processes described above is conducted in the opposite way.

FIG. 4B is a schematic representation of liquid purification system according to the present invention using a non-flowthrough elastic material. Column 201 is equipped with nozzle array 202 at the upper part and another nozzle array 203 at the lower part. The column is filled with resin 204. A non-flowthrough elastic material 205 is compacting the resin and maintains the resin in a compacted state during any cycle of operation. The elastic material accomodates the expansion of the resin bed during regeneration and the retraction during service.

During service mode with downward direction the fluid flows from upper port 206 equipped with valve, passes nozzle array 202, non-flowthrough elastic material 205 is compressing the resin bed, resin bed 204, lower nozzle array 203 and outlets at port equipped with valve 207.

During regeneration mode the regenerant flows through port 207 equipped with valve, passes through lower nozzle array 203, resin bed 204, non-flowthrough elastic material 205 is compressing the resin bed, upper nozzle array 202 with outlet at port equipped with valve 206.

The upper backwash port equipped with valve 208 is used to transfer the resin out of the column and the lower backwash port equipped with valve 209 is used to transfer the resin back to the column.

If the direction of the service mode is upward, the direction of the processes described above is conducted in the opposite way. Interconnecting pipe 210 is used to balance the pressure above and below the non-flowthrough elastic material.

FIG. 4C is a schematic representation of liquid purification system of the present invention as FIG. 4A with integrated backwash tank.

In the backwash mode the resin is transferred through the upper backwash port 308 equipped with valve to backwash tank 310. Depending on the condition of the impurities and resin fines on the resin bed the quantity of the resin to be backwashed can be adjusted as required. When the resin to be backwashed is already transferred to the backwash tank, the upper backwash port equipped with valve 308 and the lower backwash port equipped with valve 309 are closed. Backwash fluid flows through port equipped with valve 312, nozzle array 313 and clean the contaminated resin 314 through fluidization while the liquid with contaminant flows out through the upper port equipped with valve 311. To transfer the resin back to the column, after backwashing is finished, the port equipped with valve 309 is opened, port equipped with valve 312 is closed, upper port equipped with valve 306 is closed, lower port equipped with valve 307 is opened and the fluid is directed from upper port 311 to push the clean resin 314 to be transferred back to the column through the lower backwash port 309. After the transfer has been conducted both backwash valve 308 and 309 are closed and the operation of the liquid purification process can be conducted normally.

FIG. 4D is a schematic representation of liquid purification system of the present invention as FIG. 4B with integrated backwash tank. In the backwash mode the resin is transferred through the upper backwash port 408 equipped with valve to backwash tank 410. Depending on the condition of the impurities and resin fines on the resin bed the quantity of the resin to be backwashed can be adjusted as required. When the resin to be backwashed is already transferred to the backwash tank the upper backwash port equipped with valve 408 and the lower backwash port equipped with valve 409 are closed. Backwash fluid flows through port equipped with valve 412, nozzle array 413 and clean the contaminated resin 414 through fluidization while the liquid with contaminant flows out through the upper port equipped with valve 411. To transfer the resin back to the column, after backwashing is finished, the port equipped with valve 409 is closed, port equipped with valve 412 is closed, upper port equipped with valve 406 is closed, lower port equipped with valve 407 is opened and the fluid is directed from upper port 411 to push the clean resin 414 to be transferred back to the column through the lower backwash port 409. After the transfer has been conducted both backwash valve 408 and 409 are closed and the operation of the liquid purification process can be conducted normally. Interconnecting pipe 415 is used to balance the pressure above and below the non-flowthrough elastic material.

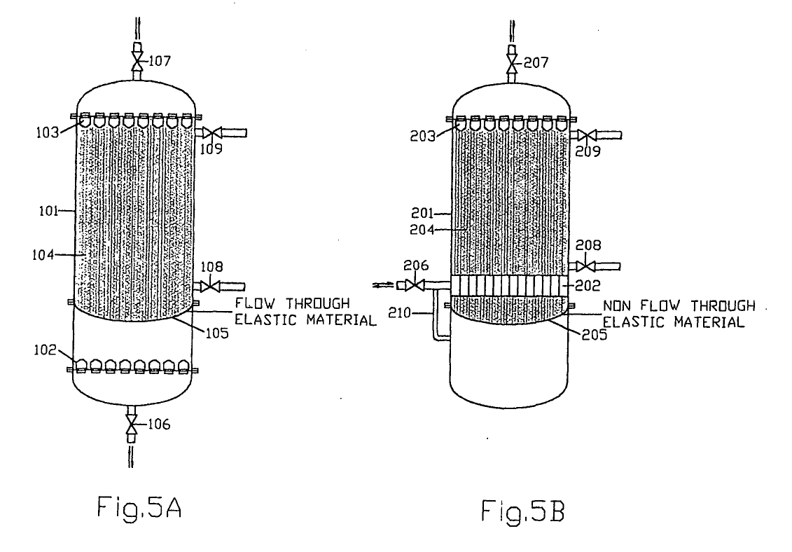

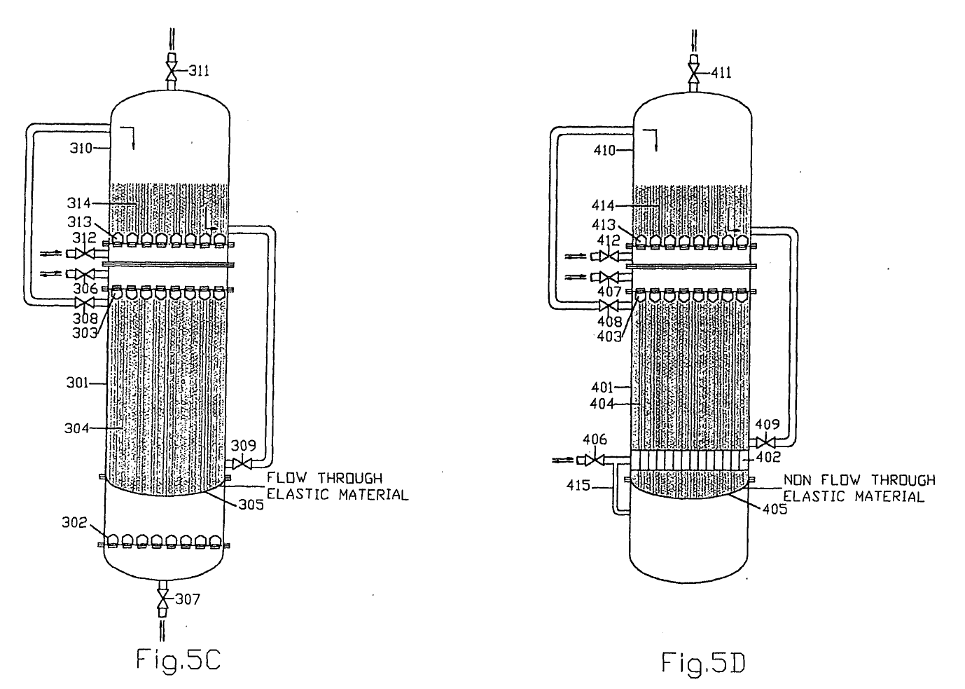

FIG. 5A is a schematic representation of liquid purification system according to the present invention using a flowthrough elastic material at the lower part. Column 101 is equipped with nozzle array 102 at the lower part and another nozzle array 103 at the upper part. The column is filled with resin 104. A flowthrough elastic material 105 is compacting the resin and maintains the resin in a compacted state during any cycle of operation. The elastic material accomodates the expansion of the resin bed during regeneration and the retraction during service.

During service mode with downward direction the fluid flows from upper port 107 equipped with valve, passes nozzle array 103, resin bed 104, flowthrough elastic material 105, lower nozzle array 102 and outlets at port equipped with valve 106.

During regeneration mode the regenerant flows through port 106 equipped with valve, passes through lower nozzle array 102, flowthrough elastic material 105, resin bed 104, upper nozzle array 103 with outlet at port equipped with valve 107.

The upper backwash port equipped with valve 109 is used to transfer the resin out of the column and the lower backwash port equipped with valve 108 is used to transfer the resin back to the column.

If the direction of the service mode is upward, the direction of the processes described above is conducted in the opposite way.

FIG. 5B is a schematic representation of liquid purification system according to the present invention using a non-flowthrough elastic material at the lower part. Column 201 is equipped with nozzle array 202 at the lower part and another nozzle array 203 at the upper part. The column is filled with resin 204. A non-flowthrough elastic material 205 is compacting the resin and maintains the resin in a compacted state during any cycle of operation. The elastic material accomodates the expansion of the resin bed during regeneration and the retraction during service.

During service mode with downward direction the fluid flows from upper port 207 equipped with valve, passes nozzle array 203, resin bed 204, lower nozzle array 202 and outlets at port equipped with valve 206 while non-flowthrough elastic material 205 is compressing the resin bed

During regeneration mode the regenerant flows through port 206 equipped with valve, passes through lower nozzle array 202, resin bed 204, upper nozzle array 203 with outlet at port equipped with valve 207 while non-flowthrough elastic material 205 is compressing the resin bed.

The upper backwash port equipped with valve 209 is used to transfer the resin out of the column and the lower backwash port equipped with valve 208 is used to transfer the resin back to the column.

If the direction of the service mode is upward, the direction of the processes described above is conducted in the opposite way. Interconnecting pipe 210 is used to balance the pressure above and below the non-flowtlurough elastic material.

FIG. 5C is a schematic representation of liquid purification system of the present invention as FIG. 5A with integrated backwash tank.

In the backwash mode the resin is transferred through the upper backwash port 308 equipped with valve to backwash tank 310. Depending on the condition of the impurities and resin fines on the resin bed the quantity of the resin to be backwashed can be adjusted as required. When the resin to be backwashed is already transferred to the backwash tank, the upper backwash port equipped with valve 308 and the lower backwash port equipped with valve 309 are closed. Backwash fluid flows through port equipped with valve 312, nozzle array 313 and clean the contaminated resin 314 through fluidization while the liquid with contaminant flows out through the upper port equipped with valve 311. To transfer the resin back to the column, after backwashing is finished, the port equipped with valve 309 is opened, port equipped with valve 312 is closed, upper port equipped with valve 306 is closed, lower port equipped with valve 307 is opened and the fluid is directed from upper port 311 to push the clean resin 314 to be transferred back to the column through the lower backwash port 309. After the transfer has been conducted both backwash valve 308 and 309 are closed and the operation of the liquid purification process can be conducted normally.

FIG. 5D is a schematic representation of liquid purification system of the present invention as FIG. 5B with integrated backwash tank. In the backwash mode the resin is transferred through the upper backwash port 408 equipped with valve to backwash tank 410. Depending on the condition of the impurities and resin fines on the resin bed the quantity of the resin to be backwashed can be adjusted as required. When the resin to be backwashed is already transferred to the backwash tank, the upper backwash port equipped with valve 408 and the lower backwash port equipped with valve 409 are closed. Backwash fluid flows through port equipped with valve 412, nozzle array 413 and clean the contaminated resin 414 through fluidization while the liquid with contaminant flows out through the upper port equipped with valve 411. To transfer the resin back to the column, after backwashing is finished, the port equipped with valve 409 is opened, port equipped with valve 412 is closed, upper port equipped with valve 407 is closed, lower port equipped with valve 406 is opened and the fluid is directed from upper port 411 to push the clean resin 414 to be transferred back to the column through the lower backwash port 409. After the transfer has been conducted both backwash valve 408 and 409 are closed and the operation of the liquid purification process can be conducted normally. Interconnecting pipe 415 is used to balance the pressure above and below the non-flowthrough elastic material.

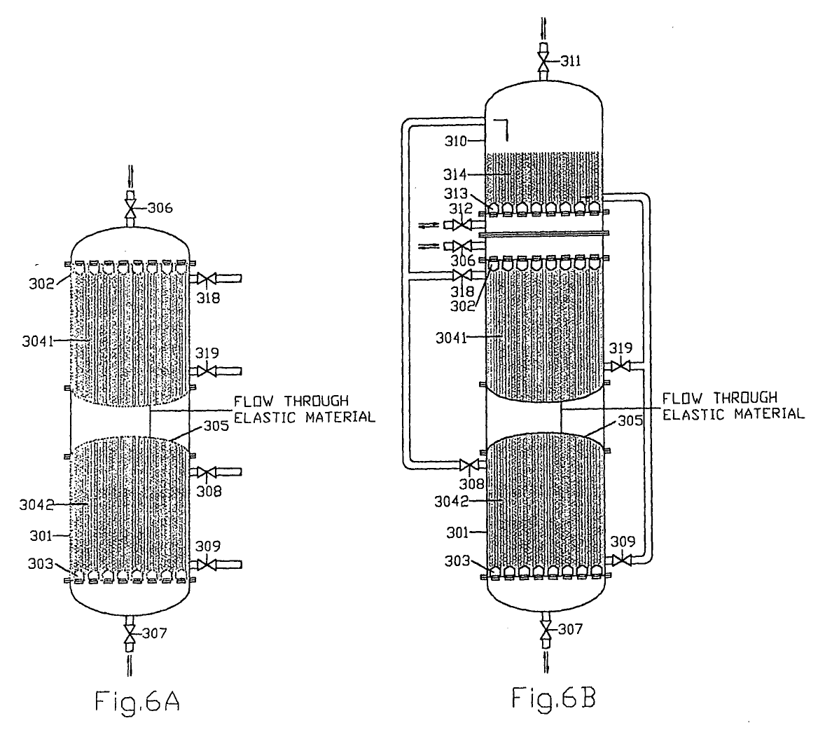

FIG. 6A is a schematic representation of liquid purification system according to the present invention using a flowthrough elastic material in the middle of the column. Column 301 is equipped with nozzle array 302 at the upper part and another nozzle array 303 at the lower part. The column is filled with resin bed 3041 above the elastic material 305 and resin bed 3042 below the elastic material 305. The flowthrough elastic material 305 is compacting the resin bed and maintains the resin in a compacted state during any cycle of operation. The elastic material accomodates the expansion of the resin bed during regeneration and the retraction during service.

During service mode with downward direction the fluid flows from upper port 306 equipped with valve, passes upper nozzle array 302, upper resin bed 3041, flowthrough elastic material 305, lower resin bed 3042, lower nozzle array 303 and outlets at port equipped with valve 307.

During regeneration mode the regenerant flows through port 307 equipped with valve, passes through lower nozzle array 303, lower resin bed 3042, flowthrough elastic material 305, upper resin bed 3041, upper nozzle array 302 with outlet at port equipped with valve 306.

The backwash ports equipped with valve 318 and 308 are used to transfer the resin out of the column from upper resin bed 3041 and lower resin bed 3042 and the lower backwash ports equipped with valve 319 and 309 are used to transfer the resin back to the upper resin bed 3041 and lower resin bed 3042 of the column respectively.

If the direction of the service mode is upward, the direction of the processes described above is conducted in the opposite way.

FIG. 6B is a schematic representation of liquid purification system of the present invention as FIG. 6A with integrated backwash tank.

In the backwash mode the resin is transferred through the upper backwash port equipped with valve 318 for the upper resin bed 3041 or through the backwash port equipped with valve 308 for the lower resin bed 3042 to backwash tank 310. Depending on the condition of the impurities and resin fines on the resin bed the quantity of the resin to be backwashed can be adjusted as required. When the resin to be backwashed is already transferred to the backwash tank, the upper backwash ports equipped with valve 318 and 308 and the lower backwash ports equipped with valve 319 and 309 are closed. Backwash fluid flows through port equipped with valve 312, nozzle array 313 and clean the contaminated resin 314 through fluidization while the liquid with contaminant flows out through the upper port equipped with valve 311. To transfer the resin back to the upper resin bed 3041, after backwashing is finished, the port equipped with valve 319 is opened, ports equipped with valve 318,308, and 309 are closed, port equipped with valve 311 is closed, upper port equipped with valve 306 is opened, lower port equipped with valve 307 is closed and the fluid is directed from lower port 312 to push the clean resin 314 to be transferred back to the upper resin bed 3041 through the lower backwash port 319. Alternatively the fluid may be directed from port 312 to push the cleaned resin back to the upper resin bed 3041 through port 319 while ports 31 land 306 are closed and port 307 is opened. To transfer the resin back to the lower resin bed 3042, after backwashing is finished, the port equipped with valve 309 is opened, ports equipped with valve 318,319, and 308 are closed, port equipped with valve 311 is closed, upper port equipped with valve 306 is opened, lower port equipped with valve 307 is closed and the fluid is directed from lower port 312 to push the clean resin 314 to be transferred back to the lower resin bed 3042 through the lower backwash port 309. Alternatively the fluid may be directed from port 312 to push the cleaned resin back to the lower resin bed 3042 through port 309 while ports 311 and 306 are closed and port 307 is opened. After the resin has been transferred back to column 301, backwash valves 318,308,319 and 309 are closed and the operation of the liquid purification process can be conducted normally.

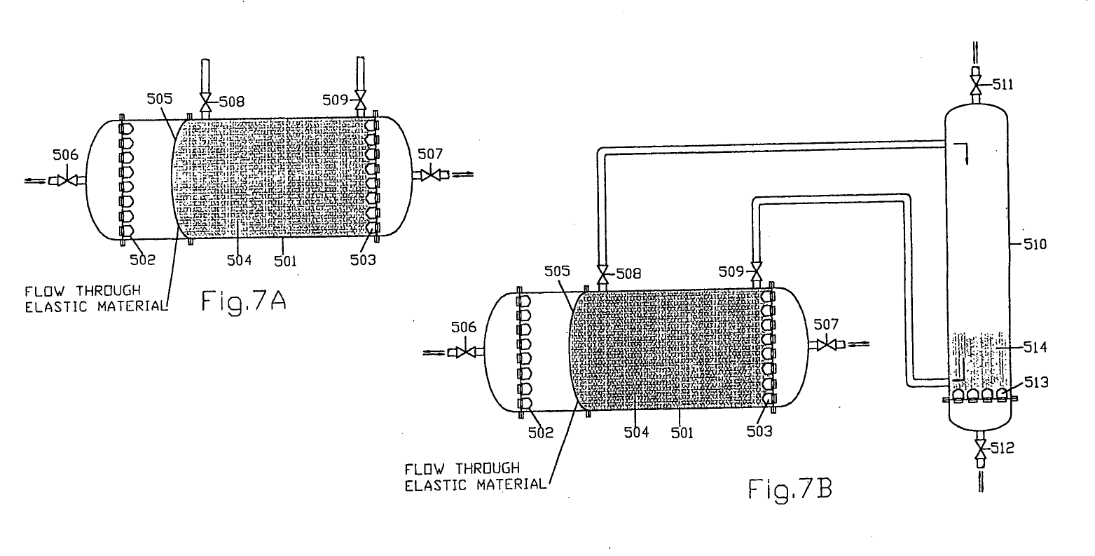

FIG. 7A is a schematic representation of liquid purification system of the present invention as FIG. 4A with the column in a horizontal position. Service flow can be conducted from left to right while the regeneration flow is from right to left or vice versa. All cycle of operations are conducted in the same procedure as described in FIG. 4A.

FIG. 7B is a schematic representation of liquid purification system of the present invention as FIG. 4C with integrated backwash tank where the column is positioned horizontally. In the backwash mode the resin is transferred through the left backwash port 508 equipped with valve to backwash tank 510. Depending on the condition of the impurities and resin fines on the resin bed the quantity of the resin to be backwashed can be adjusted as required. When the resin to be backwashed is already transferred to the backwash tank, the left backwash port equipped with valve 508 and the right backwash port equipped with valve 509 are closed. Backwash fluid flows through port equipped with valve 512, nozzle array 513 and clean the contaminated resin 514 through fluidization while the liquid with contaminant flows out through the upper port equipped with valve 511. To transfer the resin back to the column, after backwashing is finished, the port equipped with valve 509 is opened, port equipped with valve 512 is closed, left port equipped with valve 506 is closed, right port equipped with valve 507 is opened and the fluid is directed from upper port 511 to push the clean resin 514 to be transferred back to the column through the right backwash port 509. Alternatively the resin may be pushed back to column 501 by flowing the fluid from port 512, in this case port 511 is closed. After the resin has been transferred back to column 501, both backwash valve 508 and 509 are closed and the operation of the liquid purification process can be conducted normally.

1. An apparatus for conducting liquid purification utilizing an ion exchange process, the apparatus comprising a vertical liquid purification column filled with ion exchange resin, being equipped with nozzles arrays disposed inside the column located at the upper part and lower part of the column, an elastic material compressing the resin such that the resin is always in a compacted state.
The elastic material allows the resin layer to expand during regeneration and contract during service operation such that the resin is always kept in a compacted state. The elastic material can be located at any position in the column.
The column further including an inlet port at the upper part and an outlet port at the lower part in case the service flow direction is downward and the regeneration flow is upward. If the service flow direction is upward and the regeneration flow is downward the inlet port is located at the lower part and the outlet port is located at the upper part of the column.
The column is equipped with resin transfer ports, one is located at the upper part and the other is located at the lower part. The upper port is to be used for transferring the resin to a separate integrated backwash tank while the lower port is to be used to transfer the backwashed resin from the backwash tank back to the column. Alternatively the resin can be transferred to the backwash tank from the lower port and returned to the column through the upper port.

2. A liquid purification apparatus of claim 1 wherein the column is connected to another column functioning as a backwash tank through the resin transfer ports as mentioned in claim 1. After several cycles of operation the upper part of the resin may accumulate impurities and fine particles which increases the pressure drop of the system. The contaminated resin is then transferred to the backwash tank through the upper resin transfer port and after being backwashed the resin is returned to the column through the lower resin transfer port.
The backwash tank consists of nozzle arrays with backwash inlet port at the bottom and backwash outlet port at the top.
After the resin is transferred from the column to the backwash tank for backwashing, the resin will be backwashed by flowing the backwash fluid from the lower backwash port and the impurities is disposed through the upper backwash port. The backwashed resin is then transferred to the column through the lower resin transfer port.
The quantity of the resin to be backwashed depends on the necessity. The backwash tank is equipped with a resin feeding port to feed additional quantity of resin if needed.

3. A liquid purification apparatus of claim 1 wherein the resin column is positioned horizontally or at any angle of inclination.
